(19) United States
(12) Patent Application Publication
(10) Pub. No.: US 2019/0137818 A1
(43) Pub. Date: May 9, 2019

(54) LIGHT GUIDE MEMBER AND LIQUID CRYSTAL DISPLAY DEVICE

(71) Applicant: FUJIFILM CORPORATION, Tokyo (JP)

(72) Inventors: Yukito SAITO, Kanagawa (JP); Kotaro YASUDA, Kanagawa (JP)

(21) Appl. No.: 16/221,578

(22) Filed: Dec. 16, 2018

Related U.S. Application Data
(63) Continuation of application No. PCT/JP2017/022914, filed on Jun. 21, 2017.

(30) Foreign Application Priority Data
Jun. 22, 2016 (JP) 2016-123274

(51) Int. Cl. G02F 1/1335; G02F 1/13363

(52) U.S. Cl. CPC G02F 1/133602; G02F 1/13363; G02F 1/133536

(57) ABSTRACT

A light guide member includes a light guide layer that guides incident light and emits the light from at least one main surface; and a light transmission control layer that is integrally laminated to the light guide layer on a main surface side of the light guide layer that emits the light and controls a transmission amount of the light, in which the light transmission control layer has a polarization conversion layer in which the polarization conversion member is disposed on the entire surface, between two reflective polarizer layers.

### CROSS-REFERENCE TO RELATED APPLICATIONS

This application is a continuation application of International Application No. PCT/JP2017/022914, filed Jun. 21, 2017, the disclosure of which is incorporated herein by reference in its entirety. Further, this application claims priority from Japanese Patent Application No. 2016-123274, filed Jun. 22, 2016, the disclosure of which is incorporated herein by reference in its entirety.

### BACKGROUND OF THE INVENTION

### 1. Field of the Invention

The present invention relates to a light guide member used in a backlight unit of a liquid crystal display device or the like and a liquid crystal display device comprising the light guide member.

### 2. Description of the Related Art

A liquid crystal display device (hereinafter, also referred to as a liquid crystal display (LCD)) expands applications thereof as an image display device that has low power consumption and saves spaces. For example, the liquid crystal display device is formed by providing a backlight unit, a backlight side polarizing plate, a liquid crystal panel, a visible side polarizing plate, and the like in this order.

As the backlight unit, a direct-type backlight unit in which a light source is disposed under an emitting surface and an edge light-type backlight unit in which a light source is disposed laterally to the emitting surface (also referred to as a side light type) are known.

In recent years, in order to be applicable to an electronic display device such as a television or a smartphone in which an image display surface is curved, a flexible backlight unit used for a liquid crystal display device having flexibility (bendability) has been developed (for example, JP2013-008446A).

### SUMMARY OF THE INVENTION

Many of the backlight units are provided with a light guide member such as a light guide plate or a light guide film that guides light incident from the light source and emits the light from the entire main surface with substantially uniform brightness.

This light guide member is formed to propagate light over the entire area of the member while the light is totally reflected in the member, and eliminate the total reflection condition by causing the propagation direction of the light propagating in the light guide member in a light deflection portion such as a concavo-convex shape optically designed such that light is emitted with substantially uniform brightness from the entire main surface to come close to the direction orthogonal to the main surface, such that the light is extracted.

However, in a case where the light guide member of the backlight unit is bent, there was concern that the total reflection condition in the light guide member collapses, light leaks from an unintended portion, and the uniformity of the brightness and/or the front brightness of the backlight decreases.

In view of the above, an object of the present invention is to provide a light guide member used in a backlight unit of a liquid crystal display device or the like, in which decrease of uniformity of the brightness and/or front brightness of the backlight in a case of being bent is suppressed, and a liquid crystal display device comprising the light guide member.

A light guide member according to the embodiment of the present invention comprises: a light guide layer that guides incident light and emits the light from at least one main surface; and a light transmission control layer that is integrally laminated to the light guide layer on a main surface side of the light guide layer that emits the light and controls a transmission amount of the light, in which the light transmission control layer has a polarization conversion layer in which a polarization conversion member is disposed on the entire surface, between two reflective polarizer layers.

The expression “a polarization conversion member is disposed on the entire surface between two reflective polarizer layers” is not limited to a case where a polarization conversion member is completely disposed in the entire region between two reflective polarizer layers, but includes a case where a polarization conversion member is not disposed in a region that does not substantially function as a light guide member, for example, a portion between circumferential edge portions of two reflective polarizer layers.

In the light guide member according to the embodiment of the present invention, the retardation distribution on a main surface of the polarization conversion layer may be uniform, and the retardation distribution on a main surface of the polarization conversion layer may not be uniform.

The polarization conversion member may be a liquid crystal cell in which a space between two transparent electrode layers is filled with a liquid crystal material, may be a birefringent body, or may be a depolarizer.

The reflective polarizer layer may be a birefringent polymer multilayer polarization film and may be cholesteric liquid crystal.

A liquid crystal display device according to the embodiment of the present invention comprises: a liquid crystal display element on which backlight is incident from a backlight incidence surface on an opposite side of an image display surface; and a backlight unit having the light guide member according to the embodiment of the present invention and a light source that causes light to be incident on the light guide member, in which the liquid crystal display element and the light guide member are integrally laminated to each other in a state in which the backlight incidence surface of the liquid crystal display element and the light transmission control layer of the light guide member face each other, and a polarization axis direction during incidence of the backlight set in the liquid crystal display element and a polarization axis direction of light emitted from the light guide member coincide with each other.

The light guide member according to the embodiment of the present invention includes a light guide layer that guides incident light and emits the light from at least one main surface and a light transmission control layer that is integrally laminated on the light guide layer on the main surface side that emits the light of the light guide layer and controls a transmission amount of the light, and the light transmission control layer has a polarization conversion layer in which a polarization conversion member is disposed on the entire surface between two reflective polarizer layers. Therefore, in the backlight unit having this light guide member, it is possible to suppress the decrease in the uniformity of the brightness and/or the front brightness of the backlight in a case where the light guide member is bent.

The liquid crystal display device according to the embodiment of the present invention includes a liquid crystal display element on which backlight is incident from a backlight incidence surface on an opposite side to an image display surface; and a backlight unit having the light guide member according to the embodiment of the present invention and a light source that causes light to be incident on the light guide member, and the liquid crystal display element and the light guide member are integrally laminated in a state in which a backlight incidence surface of the liquid crystal display element and a light transmission control layer of the light guide member face each other, and a polarization axis direction in a case of incidence of the backlight set in the liquid crystal display element and a polarization axis direction of the light emitted from the light guide member coincide with each other. Therefore, it is possible to suppress decrease of the uniformity of the brightness and/or the front brightness of backlight in a case where the liquid crystal display device is bent. Since the light emitted from the light guide member already has polarizing properties, it is possible to omit a polarized light reflective-type brightness enhancement film and/or a polarizing plate that is generally provided between the liquid crystal display element and the backlight unit and causes the light incident on the liquid crystal display element to be predetermined polarized light. Therefore, it is possible to contribute to thinning, weight reduction, and cost reduction.

### BRIEF DESCRIPTION OF THE DRAWINGS

FIG. 1 is a schematic cross-sectional view illustrating a schematic configuration of a liquid crystal display device according to an embodiment of the present invention.

FIG. 2 is a schematic cross-sectional view illustrating a schematic configuration of the light guide member of the liquid crystal display device.

FIG. 3 is a schematic cross-sectional view illustrating a schematic configuration of a light guide member of a liquid crystal display device according to another embodiment of the present invention.

FIG. 4 is a view for describing a method of evaluating the light guide member according to the embodiment of the present invention.

### DESCRIPTION OF THE PREFERRED EMBODIMENTS

Hereinafter, embodiments of a liquid crystal display device according to the embodiment of the present invention will be described in detail with reference to the drawings.

According to the present specification, unless described otherwise, the numerical range expressed by using “to” means a range including numerical values described before and after “to” as a lower limit value and an upper limit value.

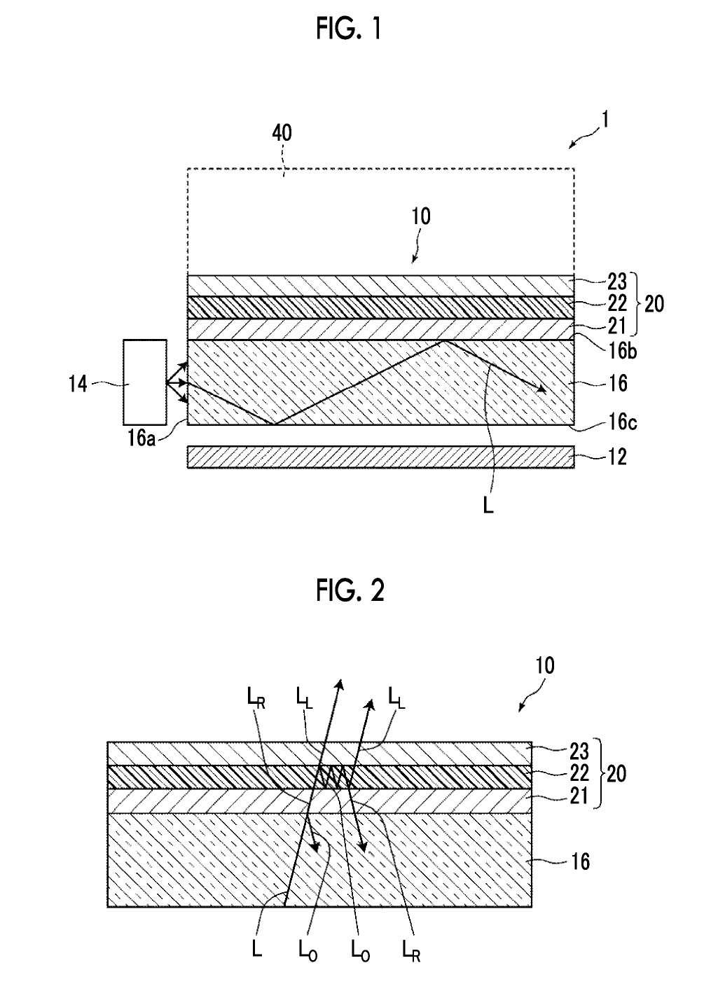

FIG. 1 is a schematic cross-sectional view illustrating a schematic configuration of a liquid crystal display device according to an embodiment of the present invention, and FIG. 2 is a schematic plan view illustrating an emitting surface side of a light guide member 10 of the liquid crystal display device 1.

This liquid crystal display device 1 has a liquid crystal display element 40 on which backlight is incident from a backlight incidence surface on an opposite side to an image display surface; and a backlight unit having the light guide member 10 and a light source 14 that causes light to be incident on an end face of the light guide member 10.

The light guide member 10 has a light guide layer 16 that guides incident light and emits the light from at least one main surface; and a light transmission control layer 20 that integrally laminated with the light guide layer 16 on a main surface side that emits light of the light guide layer 16 and controls a transmission amount of light. The light transmission control layer 20 has a polarization conversion layer 22 in which the polarization conversion member is disposed on the entire surface between two reflective polarizer layers 21 and 23.

The backlight incidence surface of the liquid crystal display element 40 and the light transmission control layer 20 of the light guide member 10 face each other, and the liquid crystal display element 40 and the light guide member 10 are integrally laminated in a state in which a polarization axis direction in a case the incidence of the backlight set in the liquid crystal display element 40 and a polarization axis direction of light emitted from the light guide member 10 coincide with each other.

As the light guide layer 16, various well-known plate-like materials (sheet-like materials) that propagate light incident from the end face in a planar direction can be used. The light guide layer 16 may be formed of a resin having high transparency as in a light guide plate used for a well-known backlight device, and examples thereof include an acrylic resin such as polyethylene terephthalate, polypropylene, polycarbonate, and polymethyl methacrylate, benzyl methacrylate, MS resin (polymethacryl styrene), a cycloolefin polymer, a cycloolefin copolymer, and cellulose acylate such as cellulose diacetate and cellulose triacetate. A refractive index of the light guide layer 16 needs to be greater than that of the air.

With respect to the light transmission control layer 20, the reflection polarization directions of the two reflective polarizer layers 21 and 23 are not particularly limited, but it is preferable to use reflective polarizer layers in which the reflection polarization directions are shifted by λ/2, and for example, one reflective polarizer layer that transmits right-handed circularly polarized light and reflects the other polarized light and the other reflective polarizer layer that transmits left-handed circularly polarized light and reflects the other polarized light may be combined with each other. Here, according to the present application, λ is set to 560 nm for convenience of explanation.

One reflective polarizer layer that transmits predetermined linearly polarized light and reflects the other polarized light and the other reflective polarizer layer that transmits linearly polarized light of which angle is inclined by an angle of 90° with respect to one reflective polarizer layer and reflects the other polarized light may be combined with each other. As the reflective polarizer layer, a well-known cholesteric liquid crystal that transmits circularly polarized light in a predetermined rotation direction may be used, or a well-known birefringent polymer multilayer polarization film that transmits linearly polarized light in a predetermined direction may be used. Specific examples of the configuration of these reflective polarizer layers 21 and 23 are provided in the following examples.

As the polarization conversion member in the polarization conversion layer 22, a well-known birefringent body may be used or a well-known depolarizer may be used. As the birefringent body, for example, a birefringent body obtained by aligning a rod-like or disk-like liquid crystal compound or a birefringent body obtained by stretching a film of a polymer such as polycarbonate may be used. As the depolarizer, for example, a scatterer containing organic or inorganic particles can be used. Specific examples of the configuration of the polarization conversion layer 22 are provided in the following examples.

The retardation distribution on the main surface of the polarization conversion layer 22 may be uniform or may not be uniform. For example, in a case where the light source 14 that can emit light with a light amount that can cause the brightness in the emitting surface of the light guide member 10 to be sufficiently uniform is used, the retardation distribution on the main surface of the polarization conversion layer 22 may be uniform, and, in order to cause the brightness in the emitting surface of the light guide member 10 to be uniform, in a case where the light source 14 having a deficient light amount is used, the retardation distribution may be adjusted such that the light transmission amount increases as it goes far from the position of the light source. The relationship of the retardation and the light transmission amount is determined by the relationship between the reflective polarizer layers 21 and 23 that sandwich the polarization conversion layer 22 and this, and is specifically described below.

In this liquid crystal display device 1, the light L emitted from the light source 14 is incident on the end face 16a of a light guide plate 16, and the total reflection between a first main surface 16b and a second main surface 16c in the light guide plate 16 is repeated for propagation. In a light deflection portion such as the minute concavo-convex shape optically designed such that light L is emitted with substantially uniform brightness from the entire first main surface 16b, in a case where the propagation direction of the light propagating in the light guide plate 16 approaches a direction orthogonal to the main surface, the total reflection condition of the light L that propagates in the light guide plate 16 is eliminated, the light is transmitted by the light transmission control layer 20 and is caused to be incident on the backlight incidence surface of the liquid crystal display element 40.

Here, the action of the light transmission control layer 20 of the light guide member 10 is described in detail with reference to FIG. 2. FIG. 2 is a schematic cross-sectional view illustrating a schematic configuration of the light guide member 10.

Here, a reflective polarizer layer 21 is a reflective polarizer layer that transmits right-handed circularly polarized light and reflects the other polarized light, a reflective polarizer layer 23 is a reflective polarizer layer that transmits left-handed circularly polarized light and reflects other polarized light, and the polarization conversion member in the polarization conversion layer 22 is a birefringent body having the λ/8 retardation.

The light L emitted from the light source 14 has light in various polarization directions, but the right-handed circularly polarized light L_{R} among the light L of which a propagation direction for propagation in the light guide plate 16 approaches a direction orthogonal to the main surface transmits the light reflective polarizer layer 21. At this point, the light that is transmitted by the light reflective polarizer layer 21 not only transmits the completely right-handed circularly polarized light L_{R} and light having a polarization state close to that of the right-handed circularly polarized light L_{R}. (hereinafter, the completely right-handed circularly polarized light L_{R} but also slightly transmits light having a polarization state close to that of the right-handed circularly polarized light L_{R} are collectively referred to as light mainly having the right-handed circularly polarized light L_{R}.)

The light L_{O} other than the light mainly having the right-handed circularly polarized light L_{R} is reflected on the reflective polarizer layer 21 and returns the light guide plate 16, the polarization state is gradually changed according to the optical characteristics of the light guide member 10 while the reflection is repeated in the light guide plate 16, and light recursion is repeated only in the light guide plate 16 until polarization properties that can be transmitted by the reflective polarizer layer 21 are obtained. Therefore, the energy loss of light due to light leak or the like is small and can contribute to high efficiency of the backlight.

The light mainly having the right-handed circularly polarized light L_{R} transmitted by the light reflective polarizer layer 21 is converted to a polarization state close to left-handed circularly polarized light L_{L} in the polarization conversion layer 22 having λ/8 retardation, and the light close to the left-handed circularly polarized light L_{L} so as to be transmitted by the reflective polarizer layer 23 among the light mainly having the right-handed circularly polarized light L_{R} is transmitted by the reflective polarizer layer 23 and incident on the backlight incidence surface of the liquid crystal display element 40.

The light L_{O} other than the light transmitted by the reflective polarizer layer 23 is reflected by the reflective polarizer layer 23 and return the polarization conversion layer 22, the polarization state is gradually changed while the reflection is repeated in the polarization conversion layer 22, and light recursion is repeated only in the polarization conversion layer 22 until polarization properties that can transmit the reflective polarizer layer 21 or 23 can be obtained. Therefore, the energy loss of light due to light leak or the like is small and can contribute to high efficiency of light usage of the backlight.

In the above configuration, among light transmitted by the reflective polarizer layer 21, the light that can be transmitted by the polarization conversion layer 22 and the reflective polarizer layer 23 at once is about 15% of the entire light, and the other light is repeatedly reflected in the light guide member 10 as described above and finally emitted from the reflective polarizer layer 23.

That is, even in a case where light leaks in an unintended portion since the total reflection condition in the light guide member 10 collapses due to the bending of the light guide member 10, most of the light does not directly transmitted by the light transmission control layer 20 and returns inside of the light guide member 10 and repeatedly reflected, and thus finally homogenization of the brightness of the backlight is obtained such that it is possible to suppress the decrease of the front brightness of the backlight.

In the above configuration, in a case where a polarization conversion member in the polarization conversion layer 22 is a birefringent body having a λ/4 retardation, among the light transmitted by the reflective polarizer layer 21, the light transmitted by the polarization conversion layer 22 and the reflective polarizer layer 23 at once becomes about 50% of the entire light. In the configuration, in a case where the polarization conversion member in the polarization conversion layer 22 is a birefringent body having a λ/2 retardation, among the light transmitted by the reflective polarizer layer 21, the light transmitted by the polarization conversion layer 22 and the reflective polarizer layer 23 at once is about 100% of the entire light. In this manner, according to the relationship between the reflective polarizer layers 21 and 23 sandwiching the polarization conversion layer 22 and this, the direct transmission amount of the light can be adjusted.

Since the light emitted from the light guide member 10 already has polarizing properties, it is possible to omit a polarized light reflective-type brightness enhancement Film and/or a polarizing plate that is generally provided between the liquid crystal display element 40 and the backlight unit and causes the light incident on the liquid crystal display element 40 to be predetermined polarized light. Therefore, it is possible to contribute to thinning, weight reduction, and cost reduction. Since light recursion is repeated only in the light guide member 10 until desired polarization properties are obtained, the energy loss of light due to light leak or the like is small. Therefore, it is possible to contribute to high efficiency of the backlight.

On the contrary to the above, in a case where the reflective polarizer layer 21 is a reflective polarizer layer that transmits left-handed circularly polarized light and reflects the other polarized light and the reflective polarizer layer 23 is a reflective polarizer layer that transmits right-handed circularly polarized light and reflects the other polarized light, in a case where, with respect to the two reflective polarizer layers 21 and 23 having different reflection polarization directions, one reflective polarizer layer that transmits a predetermined linearly polarized light and reflects the other polarized light and the other reflective polarizer layer that transmits linearly polarized light of which angle is inclined by an angle of 90° with respect to one reflective polarizer layer and reflects the other polarized light are combined with each other, and also in other cases, the principle of light transmission control is the same.

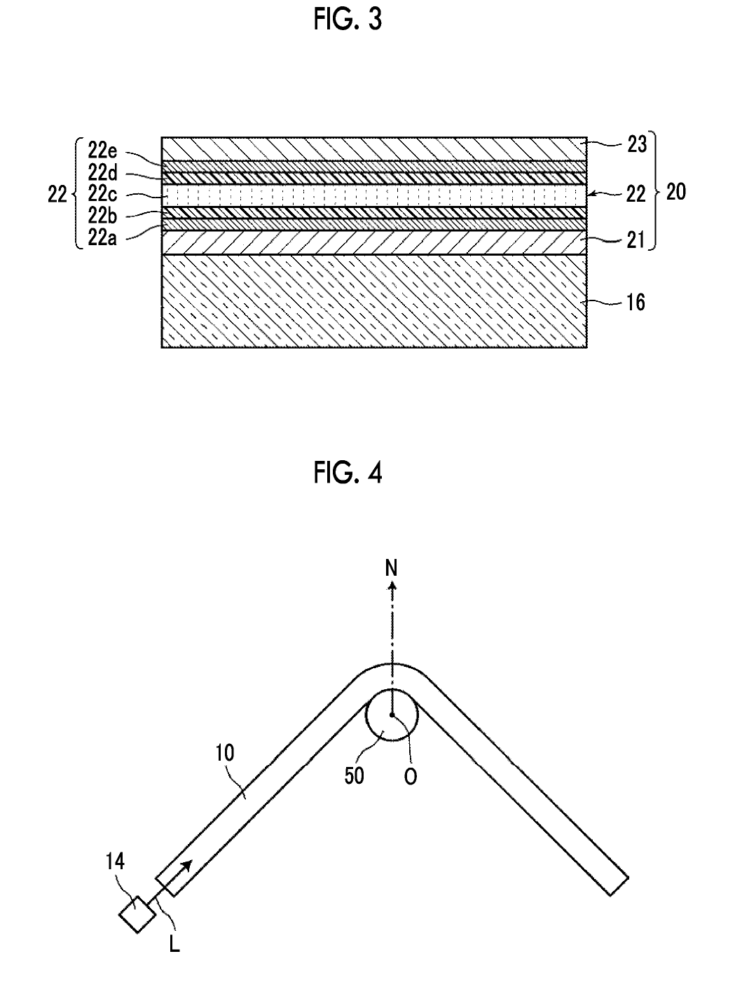

The polarization conversion member in the polarization conversion layer 22 is not limited to the birefringent body or the depolarizer. As illustrated in FIG. 3, the polarization conversion member may be a liquid crystal cell having a liquid crystal layer 22c in which a space between two transparent electrode layers 22a and 22e is filled with a liquid crystal material. This liquid crystal cell is a cell in which the transparent electrode layer 22a, an alignment film 22b, the liquid crystal layer 22c, an alignment film 22d, and the transparent electrode layer 22e are laminated in an order from the reflective polarizer layer 21 side. With respect to this liquid crystal cell, the retardation of the liquid crystal layer 22c may be discretionally adjusted by adjusting the voltage applied between the two transparent electrode layers 22a and 22e.

Each of the transparent electrode layers 22a and 22e is not limited to a single planar electrode that covers the entire main surface of the polarization conversion layer 22, and may be formed with a plurality of electrodes, for example, a plurality of linear electrodes are disposed to be parallel to each other. Since the transparent electrode layers 22a and/or 22e are formed with a plurality of electrodes, it is possible to discretionally adjust the retardation distribution on the main surface of the liquid crystal layer 22c.

By causing the polarization conversion layer 22 to be a liquid crystal cell, the in-plane uniformity of the brightness can be adjusted by the voltage, the brightness can be temporally adjusted, and the brightness can be partially adjusted in the plane, such that the present invention can be suitably used as an area backlight (local dimming-type backlight).

Specific examples of the configuration of this liquid crystal cell are provided in Examples described below.

The light source 14 may be a point light source such as a Light Emitting Diode (LED) or may be a line light source such as a rod-like fluorescence, and various kinds of well-known light sources used in an edge light-type backlight unit in the related art can be used.

According to the present embodiment, the edge light-type backlight unit on which the light is incident from the end face 16a of the light guide plate 16 is used as the backlight unit, but the present invention is not limited to the edge light-type backlight unit and may be a direct-type backlight unit on which light is incident from the second main surface 16c of the light guide plate 16.

The backlight unit may be a local dimming-type backlight that can change the brightness of the light source for each area, and various well-known light sources can be used. The local dimming-type backlight is disclosed, for example, in JP2010-049125A, JP2011-198468A, and the like.

The back surface side reflection plate 12 reflects the light emitted from the second main surface 16c of the light guide plate 16 to the light guide plate 16. By including the back surface side reflection plate 12, light utilization efficiency can be enhanced. The back surface side reflection plate 12 is not particularly limited, and various well-known plates may be used. In order to efficiently use light, it is preferable to have a reflective face having low absorption and high reflectance. For example, it is preferable to have a reflective face made of a multilayer film formed of white PET or a polyester-based resin, but the present invention is not limited thereto. Examples of the multilayer film formed of a polyester-based resin include ESR (trade name) manufactured by The 3M Company.

As illustrated in FIG. 1, the back surface side reflection plate 12 may be disposed to be spaced from the second main surface 16c of the light guide plate 16 or may be adhered to the second main surface 16c of the light guide plate 16 via a pressure sensitive adhesive or the like. In a case where the back surface side reflection plate 12 is adhered to the light guide plate 16, the light propagating through the light guide plate 16 is repeatedly reflected between the first main surface 16b of the light guide plate 16 and a reflective face 12a of the back surface side reflection plate 12 to be guided. A wavelength conversion pattern layer or a wavelength conversion layer which is represented by quantum dots may be disposed between the back surface side reflection plate 12 and the reflective polarizer layer 23. It is possible to efficiently perform wavelength conversion by light repeatedly retrograded in the light guide plate.

In the above, the liquid crystal display device according to the embodiment of the present invention is described in detail, but the present invention is not limited to the above examples, and it is obvious that various modifications and changes can be performed without departing from the gist of the present invention.

### EXAMPLES

Hereinafter, the present invention is specifically described with reference to the examples. A material, an amount used, a ratio, a treatment detail, a treatment order, and the like provided below can be suitably changed without departing from the gist of the present invention. Other configuration can be adopted other than the following configurations without departing from the gist of the present invention. That is, the configuration of the present invention should not be limited by the following specific examples. Unless described otherwise, “parts” and “%” are based on mass. Each of the retardations is a value measured by using AxoScan OPMF-1 (manufactured by Opto Science, Inc.) at a wavelength of 560 nm.

### Comparative Example 1

As a flat light guide member which was not bent, a light guide member consisting of only an acrylic light guide plate having a thickness of 400 μm and an A6 size was manufactured.

As shown in FIG. 4, as a bent light guide member to be compared, an iron bar 50 having a radius of 20 mm and heated to about 160° was pressed near the center of an acrylic light guide plate having the same A4 size and slowly bent, so as to manufacture a light guide member bent by 90°.

### Example 1a

First, a light guide member 1a-1 was manufactured.

A light transmission control layer having the following configuration was laminated on a flat acrylic light guide member of Comparative Example 1.

<<Bonding of First Reflective Polarizer Layer>>

As the linearly polarized light reflective film, iPad Air (registered trademark) manufactured by Apple Inc. was disassembled, and a film used as a brightness enhancement film was taken out to be used.

This film was bonded to one surface of a flat acrylic light guide member of Comparative Example 1 by SK2057 manufactured by Soken Chemical & Engineering Co., Ltd.

<<Manufacturing of Polarization Conversion Layer>>

As described below, the polarization conversion layer 1 as a λ/16 layer was manufactured.

<Preparation of Release Layer Coating Liquid FL-1>

The following composition was prepared and filtered with a polypropylene filter having a pore size of 0.45 μm to be used as a release layer coating liquid FL-1.

Release layer coating liquid composition (part by mass)

| | |
|---|---|
| Polymethyl methacrylate (mass average molecular weight 50,000) | 16.00 |
| Methyl ethyl ketone | 74.00 |
| Cyclohexanone | 10.00 |

<Preparation of Alignment Layer Coating Liquid AL-1>

The following composition was prepared and was filtered with a polypropylene filter having a pore size of 30 to be used as an alignment layer coating liquid AL-1.

Alignment layer coating liquid composition (part by mass)

| | |
|---|---|
| Polyvinyl alcohol (PVA205, manufactured by Kuraray Co., Ltd.) | 3.23 |
| Polyvinyl pyrrolidone (Luvitec K30, manufactured by BASF SE) | 1.50 |
| Distilled water | 57.11 |
| Methanol | 38.16 |

<Preparation of Optically Anisotropic Layer Coating Liquid LC-1>

The following composition was prepared and was filtered with a polypropylene filter having a pore size of 0.45 to be used as an optically anisotropic layer coating liquid LC-1.

LC-1-1 was a liquid crystal compound having two reactive groups: one of the two reactive groups is was an acryloyl group which was a radical reactive group, and the other was an oxetane group which was a cationic reactive group.

Optically anisotropic layer coating liquid composition (part by mass)

| | |
|---|---|
| Polymerizable liquid crystal compound (LC-1-1) | 32.88 |
| Horizontal alignment agent (LC-1-2) | 0.05 |
| Cationic photopolymerization initiator | 0.66 |
| (CPI100-P, manufactured by San-Apro Ltd.) | |
| Polymerization control agent | 0.07 |
| (IRGANOX1076, manufactured by Ciba Specialty Chemicals plc.) | |
| Methyl ethyl ketone | 46.34 |
| Cyclohexanone | 20.00 |

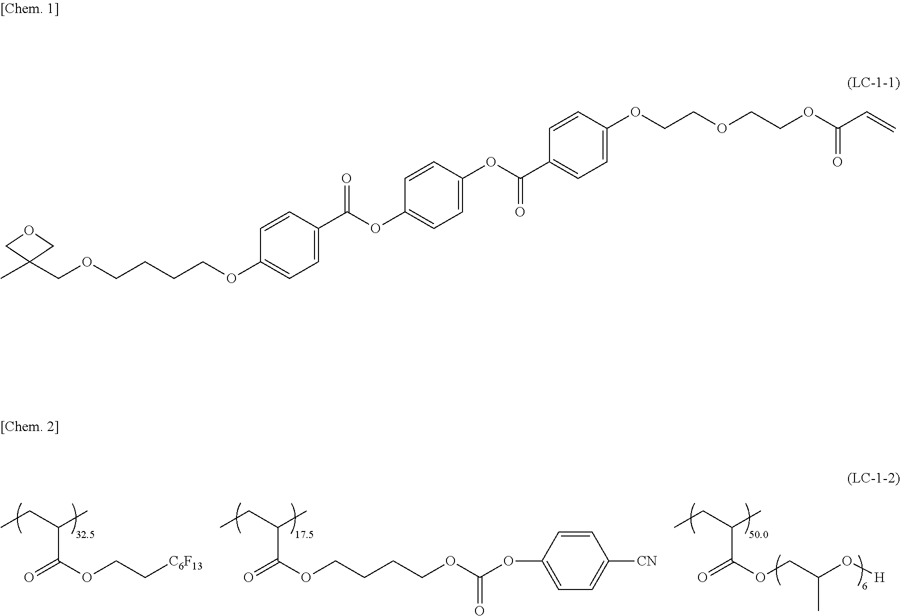

In [Chem. 2], the numerical value is mol.

<Preparation of Additive Layer Coating Liquid OC-1>

The following composition was prepared and was filtered with a polypropylene filter having a pore size of 0.45 μm to be used as a transfer adhesive layer coating liquid OC-1. As the radical photopolymerization initiator RPI-1, 2-trichloromethyl-5-(p-styrylstyryl) 1,3,4-oxadiazole was used. B-1 is a copolymer of methyl methacrylate and methacrylic acid, and the copolymerization compositional ratio (molar ratio)=60/40.

Additive layer coating liquid composition (part by mass)

| | |
|---|---|
| Binder (B-1) | 7.63 |
| Radical photopolymerization initiator (RPI-1) | 0.49 |
| Surfactant solution | 0.03 |
| (MEGAFACE F-176 PF, manufactured by DIC Corporation) | |
| Methyl ethyl ketone | 68.89 |
| Ethyl acetate | 15.34 |
| Butyl acetate | 7.63 |

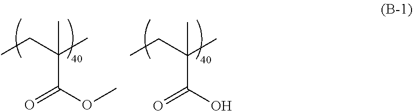

<Preparation of Heat-Sensitive Adhesive Layer Coating Liquid AD-2>

The following composition was prepared and filtered with a polypropylene filter having a pore size of 0.45 μm to be used as an adhesive layer coating liquid AD-2.

Heat-sensitive adhesive layer coating liquid composition (part by mass)

| | |
|---|---|
| Polyester-based hot melt resin solution | 37.50 |
| (PES375S40, manufactured by Toagosei Co., Ltd.) | |
| Methyl ethyl ketone | 62.50 |

<Manufacturing of Birefringent Material P-1>

Aluminum was deposited by a thickness of 60 nm on a polyethylene naphthalate film (TEONEX Q 83, manufactured by Teijin Film Solutions Limited) having a thickness of 50 μm so as to manufacture a support with a reflective layer. A surface vapor-deposited with aluminum by using a wire bar was coated with the release layer coating liquid FL-1, and the liquid was dried to form a release layer. The dry film thickness of the release layer was 2.0 μm. The dried release layer was coated with the alignment layer coating liquid AL-1 by using a wire bar, and the liquid was dried to obtain an alignment layer. The dry film thickness of the alignment layer was 0.5 μm.

Subsequently, the alignment layer was rubbing-treated and coated with the optically anisotropic layer coating liquid LC-1 by using a wire bar, the liquid was dried at a film surface temperature of 90° C. for two minutes to obtain a liquid crystal phase state and irradiated with ultraviolet rays by using an air-cooled metal halide lamp (manufactured by Eye Graphics Co., Ltd.) of 160 W/cm in air to fix the alignment state, such that an optically anisotropic layer having a thickness of 0.2 μm was formed. In this case, the illuminance of the ultraviolet rays was 600 mW/cm² in the UV-A region (integrating accumulation at the wavelength of 320 nm to 400 nm), and the irradiation amount was 300 mJ/cm² in the UV-A region. Finally, the optically anisotropic layer was coated with the additive layer coating liquid OC-1 by using a wire bar, and the liquid was dried to form an additive layer having a film thickness of 0.8 such that a birefringent material P-1 was manufactured.

<Manufacturing of Polarization Conversion Layer 1>

The birefringent material P-1 was subjected to entire surface exposure by using a digital exposure machine (INPREX IP-3600H, manufactured by Fujifilm Corporation) by laser scanning exposure using an exposure amount of 40 mJ/cm². Thereafter, heating was performed for 15 minutes by using a far-infrared heater continuous furnace, such that the film surface temperature became 210° C., so as to manufacture the optically anisotropic layer.

Finally, the additive layer was coated with the heat-sensitive adhesive layer coating liquid AD-2 by using a wire bar, and the liquid was dried to form a heat-sensitive adhesive layer having a film thickness of 2.0 and the birefringent pattern transfer foil F-1 was manufactured, so as to obtain a polarization conversion layer. This polarization conversion layer 1 was transferred to a glass substrate so as to measure the retardation thereof, and the retardation was 35 nm.

The polarization conversion layer 1 as this λ/16 layer was transferred by hot pressing onto the aforementioned first reflective polarizer layer by using a laminator at a roller temperature of 150° C., a contact pressure of 0.2 MPa, and a transportation speed of 1.0 m/min.

<<Bonding of Second Reflective Polarizer Layer>>

On the polarization conversion layer, as the second reflective polarizer layer, a linearly polarized light reflective film which was the same as the first reflective polarizer layer was bonded to the first reflective polarizer layer such that the polarization direction became orthogonal by SK2057 manufactured by manufactured by Soken Chemical & Engineering Co., Ltd. so as to obtain a flat the light guide member 1a-1 in which the light transmission control layer obtained by laminating a first reflective polarizer layer, a polarization conversion layer, and a second reflective polarizer layer on the acrylic light guide plate in this order was formed as in the cross section shape illustrated in FIG. 1.

Subsequently, a light guide member 1a-2 was manufactured.

A light transmission control layer in which the first reflective polarizer layer, the polarization conversion layer, and the second reflective polarizer layer are laminated in this order is manufactured in the same manner as the light guide member 1a-1 except that a flat acrylic light guide member is not used differently from the light guide member 1a-1.

Subsequently, the acrylic light guide member of Comparative Example 1 which was bent by 90° and the first reflective polarizer layer of the light transmission control layer were bonded by SK2057 manufactured by Soken Chemical & Engineering Co., Ltd.

The light guide member 1a-2 having a 90° bent portion was manufactured.

### Example 1b

With respect to each of Examples 1a-1 and 1a-2, the polarization conversion layer 1 was set as the polarization conversion layer 2, as the λ/8 layer.

The manufacturing of the birefringent material P-1 was the same as the manufacturing of Examples 1a-1 and 1a-2, except that the thickness of the optically anisotropic layer was 0.4 This polarization conversion layer 2 was transferred to a glass substrate so as to measure the retardation thereof, and the retardation was 70 nm.

### Example 1c

With respect to each of Examples 1a-1 and 1a-2, the polarization conversion layer 1 was set as the polarization conversion layer 3, as the λ/4 layer.

The manufacturing of the birefringent material P-1 was the same as the manufacturing of Examples 1a-1 and 1a-2, except that the thickness of the optically anisotropic layer was 0.8 This polarization conversion layer 3 was transferred to a glass substrate so as to measure the retardation thereof, and the retardation was 135 nm.

### Example 1d

With respect to each of Examples 1a-1 and 1a-2, the polarization conversion layer 1 was set as the polarization conversion layer 4, as the λ/2 layer.

The manufacturing of the birefringent material P-1 was the same as the manufacturing of Examples 1a-1 and 1a-2, except that the thickness of the optically anisotropic layer was 1.6 This polarization conversion layer 4 was transferred to a glass substrate so as to measure the retardation thereof, and the retardation was 270 nm.

### Example 2

First, a light guide member 2-1 was manufactured.

A light transmission control layer having the following configuration was laminated on a flat acrylic light guide member of Comparative Example 1.

<<Manufacturing of First Reflective Polarizer Layer>>

The following composition was stirred and dissolved in a container kept at 25° C. so as to prepare a cholesteric liquid crystal ink liquid (liquid crystal composition). A right twist chiral agent A having the following structure and a left twist chiral agent B having the following structure were included in a cholesteric liquid crystal ink liquid (liquid crystal composition), and additionally, a liquid described in the following “cholesteric liquid crystal ink liquid (part by mass)” was contained. In the cholesteric liquid crystal ink liquid (liquid crystal composition), without changing an amount (part by mass) of a material contained other than the followings, only types of the chiral agent which was the right twist chiral agent A or the left twist chiral agent B and amounts (part by mass) of the right twist chiral agent A and the left twist chiral agent B were adjusted as presented in Table 1 below according to center selection wavelengths so as to prepare a cholesteric liquid crystal for reflecting a specific center selection wavelength. In a case where dots that reflect right-handed circularly polarized light were formed, as the chiral agent, only the right twist chiral agent A was added by an amount (part by mass) corresponding to the center selection wavelength illustrated in Table 1 below. In a case where dots that reflect the left-handed circularly polarized light were formed, as the chiral agent, only the left twist chiral agent B was added by an amount (part by mass) corresponding to the center selection wavelength presented in Table 1.

<Right Twist Cholesteric Liquid Crystal Ink Liquid (Part by Mass)>

| | |
|---|---|
| Methoxyethyl acrylate | 145.0 |
| Mixture of the following rod-like liquid crystal | 100.0 |
| compounds | |
| IRGACURE (registered trademark) 819 | 10.0 |
| (manufactured by BASF SE) | |
| Right twist chiral agent A having the | See Table 1 below |
| following structure | |
| Surfactant having the following structure | 0.08 |

<Left Twist Cholesteric Liquid Crystal Ink Liquid (Part by Mass)>

| | |
|---|---|
| Methoxyethyl acrylate | 145.0 |
| Mixture of the following rod-like liquid crystal | 100.0 |
| compounds | |
| IRGACURE (registered trademark) 819 | 10.0 |
| (manufactured by BASF SE) | |
| Left twist chiral agent B having the following | See Table 1 below |
| structure | |
| Surfactant having the following structure | 0.08 |

### Rod-Like Liquid Crystal Compound

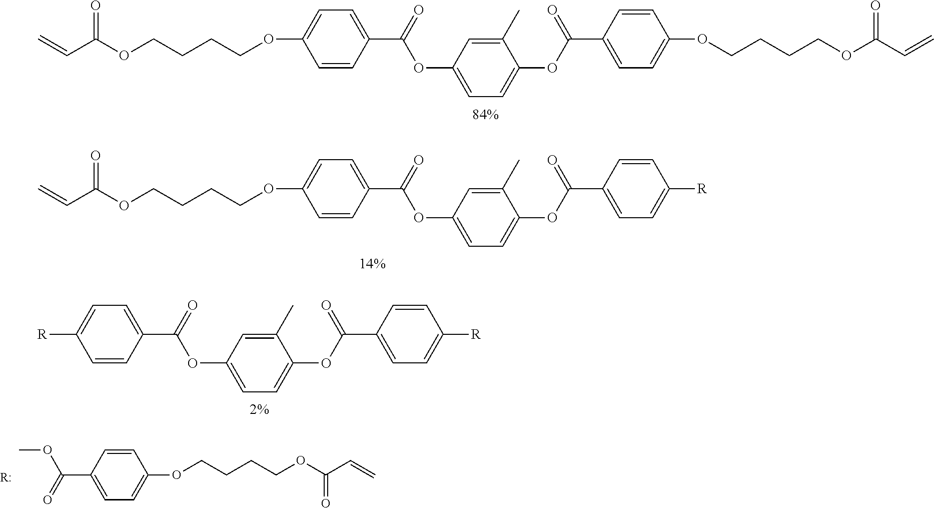

The numerical number is mass %. R is a group bonded by an enzyme.

### Right Twist Chiral Agent A

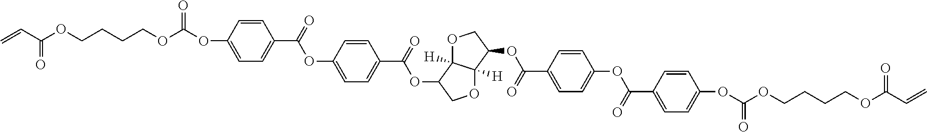 [SMILES: C=CC(=O)OCCCCOC(=O)Oc1ccc(C(=O)Oc2ccc(C(=O)OC3CO[C@H]4[C@@H]3OC[C@H]4OC(=O)c3ccc(OC(=O)c4ccc(OC(=O)OCCCCOC(=O)C=C)cc4)cc3)cc2)cc1]

### Left Twist Chiral Agent B

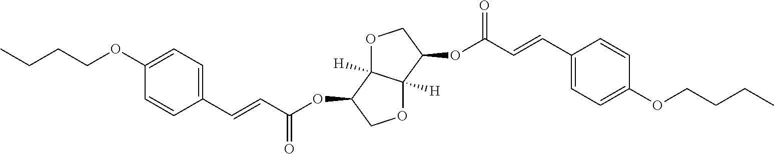 [SMILES: CCCCOc1ccc(/C=C/C(=O)O[C@@H]2CO[C@H]3[C@@H]2OC[C@H]3OC(=O)/C=C/c2ccc(OCCCC)cc2)cc1]

### Surfactant

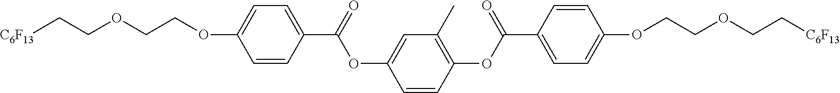

Based on Table 1 below, a cholesteric liquid crystal ink liquid was adjusted according to the center selection wavelength and the form of reflected polarized light.

TABLE 1

| Center selection | Part by mass of right twist | Part by mass of left twist |
|---|---|---|
| wavelength (nm) | chiral agent A | chiral agent B |
| 450 | 7.61 | 9.59 |
| 550 | 5.78 | 7.85 |
| 650 | 4.66 | 6.64 |
| 750 | 4.52 | 5.76 |

One surface of the flat acrylic light guide member of Comparative Example 1 was coated with an alignment film coating liquid consisting of 10 parts by mass of polyvinyl alcohol and 371 parts by mass of water, and the alignment film coating liquid was dried, so as to form an alignment film having a thickness of 1 μm. Next, a rubbing treatment was performed on the alignment film continuously in a direction parallel to the longitudinal direction of the film.

A right twist liquid crystal ink with a center selection wavelength of 450 nm in Table 1 was applied to the alignment film using a bar coater, was dried at room temperature for 10 seconds, then was heated (alignment ripened) in an oven at 100° C. for two minutes, and was irradiated with ultraviolet rays for 30 seconds, so as to manufacture a cholesteric liquid crystal layer having a thickness of 5 μm.

The cholesteric liquid crystal layer was coated with a right twist liquid crystal ink in a center selection wavelength of 550 nm in Table 1 by using a bar coater, the ink was dried at room temperature for 10 seconds, then was heated (alignment ripened) in an oven at 100° C. for two minutes, and was irradiated with ultraviolet rays for 30 seconds, so as to manufacture a layer by laminating cholesteric liquid crystal having a thickness of 5 μm on the underlayer.

The layer was coated with a right twist liquid crystal ink having a center selection wavelength of 650 nm presented in Table 1 by using a bar coater, the ink was dried at room temperature for 10 seconds, then was heated (alignment ripened) in an oven at 100° C. for two minutes, and was irradiated with ultraviolet rays for 30 seconds, so as to manufacture a layer by laminating cholesteric liquid crystal having a thickness of 5 μm on the underlayer.

The layer was coated with a right twist liquid crystal ink having a center selection wavelength of 750 nm presented in Table 1 by using a bar coater, the ink was dried at room temperature for 10 seconds, then was heated (alignment ripened) in an oven at 100° C. for two minutes, and was irradiated with ultraviolet rays for 30 seconds, so as to manufacture a layer by laminating cholesteric liquid crystal having a thickness of 5 μm on the underlayer.

In this manner, a first reflective polarizer layer, which was a laminated layer of four cholesteric liquid crystals, was manufactured. The cross section was observed with a scanning electron microscope to find that the first reflective polarizer layer had a structure in which four layers having helical axes in a layer normal direction and having different cholesteric pitches were laminated and a pitch thereof corresponded to the center selection wavelengths of 450, 550, 650, and 750 nm. The reflection spectrum was measured with Axoscan to confirm that the right-handed circularly polarized light was reflected by four reflection bands mainly of 450, 550, 650, and 750 nm and to confirm that the first reflective polarizer layer had reflection bands of the right-handed circularly polarized light which became wider as it goes from the visible light region toward the near-infrared region.

<<Manufacturing of Polarization Conversion Layer>>

The manufacturing was performed in the same manner as in Example 1b.

<<Manufacturing of Second Reflective Polarizer Layer>>

PET (thickness of 75 μm) manufactured by Fujifilm Corporation was prepared as a temporary support, and rubbing treatment was continuously performed. A second reflective polarizer layer was manufactured on the temporary support as below.

The method of manufacturing the second reflective polarizer layer is the same as the method of manufacturing the first reflective polarizer layer except that a support of the first reflective polarizer layer was changed to a temporary support, and a cholesteric liquid crystal ink liquid in which the right twist chiral agent A was changed to the left twist chiral agent B was used (see Table 1). In this manner, the second reflective polarizer layer was manufactured.

In the same manner as in the first reflective polarizer layer, the cross section was observed with a scanning electron microscope to find that the second reflective polarizer layer had a structure in which four layers having helical axes in a layer normal direction and having different cholesteric pitches were laminated and a pitch thereof corresponded to the center selection wavelengths of 450, 550, 650, and 750 nm. The reflection spectrum was measured with Axoscan to confirm that the left-handed circularly polarized light was reflected by four reflection bands mainly of the center selection wavelengths of 450, 550, 650, and 750 nm and to confirm that the second reflective polarizer layer had reflection bands of the left-handed circularly polarized light which became wider as it goes from the visible light region toward the near-infrared region.

The coated surface of the second reflective polarizer layer and the surface where the polarization conversion layer 2 as a λ/8 layer was present were bonded by using SK2057 manufactured by Soken Chemical & Engineering Co., Ltd., and after bonding, the temporary support on the second reflective polarizer layer side was peeled off, so as to obtain a flat the light guide member 2-1 in which the light transmission control layer obtained by laminating a first reflective polarizer layer, a polarization conversion layer, and a second reflective polarizer layer on the acrylic light guide plate in this order was formed as in the cross section shape illustrated in FIG. 1.

Subsequently, a light guide member 2-2 was manufactured. First, in the manufacturing of the first reflective polarizer layer, except that PET (thickness of 75 μm) manufactured by Fujifilm Corporation which was a temporary support was used instead of using the flat acrylic light guide member and the first reflective polarizer layer was transferred to the polarization conversion layer, in the same manner as in the light guide member 1-1, a transfer member obtained by laminating the second reflective polarizer layer, the polarization conversion layer, and the first reflective polarizer layer on the temporary support in this order was manufactured.

Subsequently, layers were transferred from the temporary support to the acrylic light guide member bent at 90°, such that the first reflective polarizer layer, the polarization conversion layer, and the second reflective polarizer layer were in this order. At this point, the bent acrylic light guide member and the first reflective polarizer layer were bonded by using SK2057 manufactured by Soken Chemical & Engineering Co., Ltd.

The light guide member 2-2 having a 90° bent portion was manufactured.

### Example 3

In the light guide member of Example 1a, the configuration was changed such that the polarization conversion layer of the light transmission control layer was formed by a scattering material (depolarizer).

100 parts by mass of dipentaerythritol hexaacrylate {manufactured by Nippon Kayaku Co., Ltd.} as a light transmitting resin for forming the scattering material, 9 parts by mass of melamine resin particles “Opto bead 2000M” as light transmitting particles, and 6 parts by mass of a polymerization initiator “IRGACURE 184” were mixed and prepared so as to have a solid content of 50 mass % by methyl ethyl ketone/methyl isobutyl ketone (30/70 mass ratio).

The above light transmitting resin was applied so as to have a dry film thickness of 1.0 the solvent was dried, irradiated with ultraviolet rays having an illuminance of 1.5 kW/cm² and an irradiation amount of 95 mJ/cm² by using an air-cooling metal halide lamp (manufactured by Eye Graphics Co., Ltd.) of 160 W/cm so as to cure the resin, such that a polarization conversion layer consisting of the scattering material is formed.

### Example 4

In the light guide member of Example 2, the configuration was changed such that the polarization conversion layer of the light transmission control layer was formed by a scattering material (depolarizer) in the same manner as in Example 3.

### Example 5

In the light guide member of Example 1a, the configuration was changed such that the polarization conversion layer of the light transmission control layer was formed by a liquid crystal cell.

This liquid crystal cell was manufactured with reference to JP2000-347170A. First, a transparent electrode of indium tin oxide (ITO) was sputtered on one surface of two polycarbonate films. Next, STX-24 manufactured by Hitachi Chemical Co., Ltd., which was a low temperature curable polyimide, was diluted and dissolved in N-methylpyrrolidone as an aligning agent and spin-coated on ITO of a polycarbonate film. After thermal curing, rubbing was performed with a polyester-based rubbing roll in a rubbing machine. PHOTOLEC S (manufactured by Sekisui Chemical Co., Ltd.) was applied to the ITO side of one sheet of the polycarbonate film on the outer periphery of the display portion, subsequently ZLI-4792 manufactured by Fine Chemical Division of Sekisui Chemical Co., Ltd. in which micropearls were dispersed was dropwise added as a spacer with a liquid crystal dispenser, another polycarbonate film was aligned such that the rubbing directions were antiparallel, and liquid crystal was injected by a vacuum dropping method so as to manufacture a cell. The cell gap was 3 μm.

In a case where a rectangular wave voltage of 60 Hz was applied to the ITO of the two substrates, the retardation decreased as the voltage increased, the retardation was 300 nm at the voltage of 0 V, 140 nm at the voltage of 3 V, 60 nm at 5 V, 28 nm at 10 V, and 17 nm at 15 V.

[Evaluation Method]

For each of Comparative Example 1 and Examples 1a to 5, the front brightness of the flat light guide member and the front brightness of the light guide member having the 90° bent portion were compared. The front brightness was obtained by causing light to be incident on the end face of the light guide member 10 as illustrated in FIG. 4 (an example of a 90° bent light guide member) and measuring the brightness in the normal N direction of the surface at the center position of the light guide member by using BM-5A manufactured by Topcon Corporation.

The above evaluation results are presented in Table 2.

TABLE 2

| | | | Comparative | | | | |
|---|---|---|---|---|---|---|---|
| | | | Example 1 | Example 1a | Example 1b | Example 1c | Example 1d |
| Structure | Configuration of reflective polarizer layer | | None | APF | APF | APF | APF |
| | Configuration of polarization conversion | | None | Birefringent | Birefringent | Birefringent | Birefringent |
| | material | | | material (λ/16) | material (λ/8) | material (λ/4) | material (λ/2) |
| | | | | Re = 35 nm | Re = 70 nm | Re = 135 nm | Re = 270 nm |
| Effect | Front brightness maintenance | Preferable | A | | | | |
| | ratio in a case where light | result | | | | | |
| | guide plate is bent | Measurement | E | C | A | B | C |
| | | result | | | | | |
| | | | | Example 2 | Example 3 | Example 4 | Example 5 |

| Structure | Configuration of reflective polarizer layer | | Cholesteric | APF | Cholesteric | APF |
|---|---|---|---|---|---|---|
| | Configuration of polarization conversion material | | Birefringent | Scatterer | Scatterer | Liquid crystal cell |
| | | | material (λ/8) | Resin including | Resin including | Re = 300 nm, |
| | | | Re = 70 nm | beads of 30% | beads of 30% | Application of 5 V |
| Effect | Front brightness maintenance | Preferable result | A | | | |
| | ratio in a case where light | Measurement result | B | C | C | A |
| | guide plate is bent | | | | | |

<Evaluation Standard>

The ratio (front brightness maintenance ratio) of the front brightness of the light guide member having the 90° bent portion to the front brightness of the flat light guide member was as follows.

A: 100% or less and 85% or more

B: Less than 85% and 75% or more

C: Less than 75% and 65% or more

D: Less than 65% and 60% or more

E: Less than 60%

In this evaluation, it is preferable that the front brightness did not decrease in a state in which the light guide member was bent by 90°, that is, A is the most satisfactory.

As presented in Table 2, in the light guide plate in the related art (Comparative Example 1) not having a light transmission control layer, the evaluation of the front brightness maintenance ratio was E, and in the state where the light guide member was bent by 90°, the front brightness greatly decreased. However, in the light guide members (Examples 1a to 5) of the embodiments of the present invention, the evaluation of the front brightness maintenance ratio was C or more, and it was found that the decrease in the front brightness maintenance ratio was smaller than the light guide plate in the related art.

According to the evaluation results of Examples 1a to 1d, in a case where the polarization direction of the two reflective polarizer layers was deviated by 90°, in the case where the polarization conversion layer was a λ/8 layer (Example 1b), a most front brightness maintenance ratio became high.

In Example 5, in a case where the voltage was 5 V, the retardation was the same as in a case of the λ/8 layer, and thus the evaluation of the front brightness maintenance ratio was A as in Example 1b. Though it was not shown in the table, it was confirmed that the brightness at the voltage 3 V became lower than that at the voltage of 5 V, and thus the evaluation became B. At the voltage of 15 V, it was confirmed that the brightness was smaller than that at the voltage of 5 V, and thus the evaluation became C. It was possible to confirm that the brightness was able to be adjusted at the voltage.

Even in a case where the light guide member manufactured in a flat state is bent after being manufactured, the same effect as the light guide member manufactured in the bent state as described above can be obtained.

From the above, the effect of the present invention is obvious.

### EXPLANATION OF REFERENCES

1: liquid crystal display device
10: light guide member
12: back surface side reflection plate
14: light source
16: light guide plate
16a: end face of light guide plate
16b: first main surface of light guide plate
16c: second main surface of light guide plate
20: light transmission control layer
21: reflective polarizer layer
22: polarization conversion layer
23: reflective polarizer layer
40: liquid crystal display element
50: iron rod
L: light
L_{L}: left-handed circularly polarized light
L_{O}: other polarized light
L_{R}: right-handed circularly polarized light
N: normal direction

What is claimed is:

1. Alight guide member comprising:
a light guide layer that guides incident light and emits the light from at least one main surface; and
a light transmission control layer that is integrally laminated to the light guide layer on a main surface side of the light guide layer that emits the light and controls a transmission amount of the light,
wherein the light transmission control layer has a polarization conversion layer in which a polarization conversion member is disposed on the entire surface, between two reflective polarizer layers.

2. The light guide member according to claim 1,
wherein retardation distribution on a main surface of the polarization conversion layer is uniform.

3. The light guide member according to claim 1,
wherein retardation distribution on a main surface of the polarization conversion layer is not uniform.

4. The light guide member according to claim 1,
wherein the polarization conversion member is a liquid crystal cell in which a space between two transparent electrode layers is filled with a liquid crystal material.

5. The light guide member according to claim 1,
wherein the polarization conversion member is a birefringent body.

6. The light guide member according to claim 1,
wherein the polarization conversion member is a depolarizer.

7. The light guide member according to claim 1,
wherein the reflective polarizer layer is a birefringent polymer multilayer polarization film.

8. The light guide member according to claim 1,
wherein the reflective polarizer layer is a cholesteric liquid crystal.

9. A liquid crystal display device comprising:
a liquid crystal display element on which backlight is incident from a backlight incidence surface on an opposite side of an image display surface; and
a backlight unit having the light guide member according to claim 1 and a light source that causes light to be incident on the light guide member,
wherein the liquid crystal display element and the light guide member are integrally laminated to each other, in a state in which the backlight incidence surface of the liquid crystal display element and the light transmission control layer of the light guide member face each other, and a polarization axis direction during incidence of the backlight set in the liquid crystal display element and a polarization axis direction of light emitted from the light guide member coincide with each other.
